(19) United States
(12) Patent Application Publication
(10) Pub. No.: US 2015/0090365 A1
(43) Pub. Date: Apr. 2, 2015

(54) FILLING MACHINE

(71) Applicant: KHS GmbH, Dortmund (DE)

(72) Inventor: Ludwig Clüsserath, Bad Kreuznach (DE)

(21) Appl. No.: 14/400,110

(22) PCT Filed: Mar. 20, 2013
(86) PCT No.: PCT/EP2013/000836

§ 371 Date: Nov. 10, 2014

(30) Foreign Application Priority Data
May 10, 2012 (DE) 10 2012 009 206.7

(51) Int. Cl. B67C 7/00; B67C 3/06

(52) U.S. Cl. CPC B67C 7/0046; B67C 3/06; B67C 2007/006
USPC 141/40; 141/85

(57) ABSTRACT

A filling machine includes a transport element that rotates about a machine axis, filling positions formed on the transport element, rinsing caps assigned to corresponding filling positions, and a housing. Each filling position has a filling element that forms a discharge opening. Each rinsing cap moves between a starting position and a working position. In the starting position, the rinsing cap is outside a movement space through which the filling elements move during filling. In the working position, it forms a cleaning path that includes the discharge opening. The rinsing caps are disposed on a part of the housing that is stationary relative to the transport element.

### RELATED APPLICATIONS

This application is the national stage under 35 USC 371 of PCT/EP2013/000836, filed on Mar. 20, 2013, which claims the benefit of the May 10, 2012 priority date of German application DE 102012009206.7, the contents of which are herein incorporated by reference.

### FIELD OF DISCLOSURE

The invention relates to processing of containers, and in particular, to filling machines for filling containers with liquid filling material.

### BACKGROUND

In known filling machines, a rotating transporting element, or rotor, carries filling elements for filling containers. These filling elements occasionally need to be cleaned. Known filling machines incorporate cleaning fixtures that are used to clean the filling elements.

A difficulty that arises is that the cleaning fixtures are all arranged on the rotor. This results in a thick structure that restricts structural freedom.

Another difficulty that arises is that, in many cases, drives for moving the cleaning fixtures are arranged inside a chamber in which the containers are filled. This creates additional surfaces with crevices where treatment medium or its condensate can be deposited. These make it more difficult to remove these remnants of the cleaning process.

### SUMMARY

A filling machine according to the invention avoids the aforesaid disadvantages and allows a simplified structural design with a high level of operating reliability.

In one aspect, the invention features an apparatus for filling containers with liquid filling material. Such an apparatus includes a filling machine. The filling machine has a transport element, filling positions, rinsing caps, each of which is assigned to one of the filling positions, and a housing having a part that is stationary relative to the transport element. Each filling position has a filling element and a container carrier. The transport element is rotatable about a machine axis. The filling element forms a discharge opening for the filling material. The filling positions are formed on the transport element, and therefore rotate about the machine axis with the transport element. Each rinsing cap is movable between a starting position and a working position. In the starting position, the rinsing cap is arranged outside a movement space through which the filling elements move during a filling operation. In the working position, the rinsing cap forms a cleaning path that includes the discharge opening. The rinsing caps are disposed on the stationary part of the housing.

In some embodiments, the housing forms an isolator chamber. In these embodiments, the filling element is disposed in the isolator chamber during filling of containers by the filling element. Among these embodiments are those that further include a drive that moves the rinsing cap. The drive is disposed outside the isolator chamber between the starting and working positions.

In other embodiments, the rinsing cap is configured to swivel around a swivel axis thereof when moving between the starting position and the working position. Among these are embodiments in which the swivel axis is oriented to be parallel to the machine axis, embodiments in which the swivel axis is disposed outside a movement path along which the filling elements rotate about the machine axis as a result of being moved by the transport element, and embodiments in which the swivel axis is disposed inside a movement path along which the filling elements rotate about the machine axis as a result of being moved by the transport element.

In some embodiments, the rinsing cap is configured to move along an axis when moving between the starting position and the working position. The axis along which the rinsing cap is configured to move is an axis that is parallel to the machine axis.

In other embodiments, the rinsing cap is configured to move along an axis when moving between the starting position and the working position. In these embodiments, the axis along which the rinsing cap is configured to move is parallel to a filling element axis of a filling element of a filling position assigned to the rising cap.

In other embodiments, the rinsing cap is movable along a line.

Also among the embodiments are those in which the rinsing cap is configured to seal tightly against the filling element in the working position to form the cleaning path as a result of relative movement between the rinsing cap and the filling element in an axial direction that is parallel to a filling element axis of the filling element.

In other embodiments, the rinsing cap is configured to seal tightly against the filling element in the working position to form the cleaning path as a result of relative movement between the rinsing cap and the filling element in an axial direction that is parallel to a swivel axis of the rinsing cap.

In yet other embodiments, the rinsing cap further comprises a return flow channel for treatment medium. The treatment medium can be cleaning medium or sterilization medium. In either case, the treatment medium can be liquid, gaseous, or vaporous.

Also among the embodiments are those in which the housing has a movable part that movable part rotates with the transport element as overlaps the stationary part.

Other embodiments feature a closure. When the rinsing cap is in the starting position, the closure closes the rinsing cap.

The invention is applicable to various filling techniques. For example, in one embodiment, the filling machine comprises a free-jet filling machine. In another embodiment, the filling machine comprises a counter-pressure filling machine.

In another aspect, the invention features a filling machine that includes a transport element that rotates about a machine axis, filling positions formed on the transport element, rinsing caps assigned to corresponding filling positions, and a housing. Each filling position has a filling element that forms a discharge opening. Each rinsing cap moves between a starting position and a working position. In the starting position, the rinsing cap is outside a movement space through which the filling elements move during filling. In the working position, it forms a cleaning path that includes the discharge opening. The rinsing caps are disposed on a part of the housing that is stationary relative to the transport element.

As used herein, “packages” are containers such as cans, bottles, tubes, pouches, in each case made of metal, glass and/or plastic, but also includes other containers that are suitable for filling with liquid or viscous products.

As used herein, “free-jet filling” means a process in which the liquid filling material flows to the packages or containers to be filled in a free filling jet so that a package does not lie with their mouth or opening against a filling element, but is instead at a distance from the filling element or from a filling material outlet.

As used herein, the expression “substantially” or “approximately” means deviations from exact values in each case by ±10%, and preferably by ±5% and/or deviations in the form of changes not significant for functioning.

Further developments, benefits and application possibilities of the invention arise also from the following description of examples of embodiments and from the figures. In this regard, all characteristics described and/or illustrated individually or in any combination are categorically the subject of the invention, regardless of their inclusion in the claims or reference to them. The content of the claims is also an integral part of the description.

### BRIEF DESCRIPTION OF THE DRAWINGS

The invention is explained in more detail below by means of the figures using examples of embodiments. In the figures:

FIG. 1 is a schematic representation of a view from above of a rotating filling machine for the aseptic free-jet filling of containers with a liquid filling material;

FIG. 2 is a schematic partial representation in section of one of the filling positions of the filling machine in FIG. 1 together with a housing, or isolator, that holds the containers during the filling process;

FIG. 3 shows the filling position in FIG. 2 during cleaning with a treatment medium, e.g. during the CIP cleaning and/or sterilization;

FIG. 4 shows a representation as in FIG. 3 of a further embodiment of the filling machine according to the invention;

FIG. 5 a section view along the line I-I in FIG. 4; and

FIGS. 6 and 7 are representations similar to FIGS. 3 and 4 of further embodiments of the invention.

### DETAILED DESCRIPTION

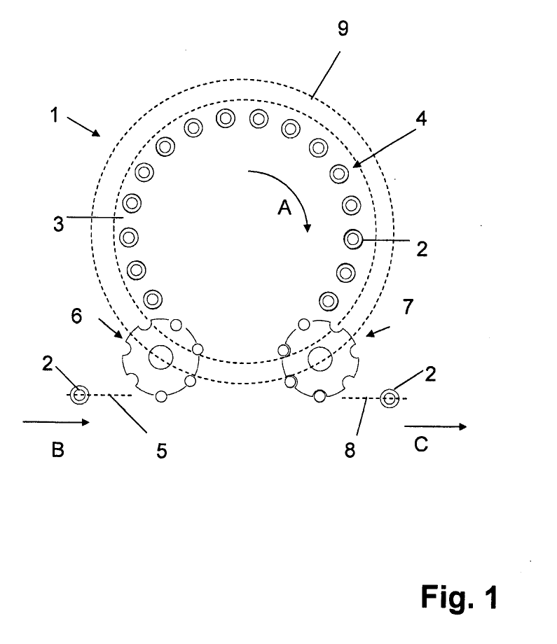

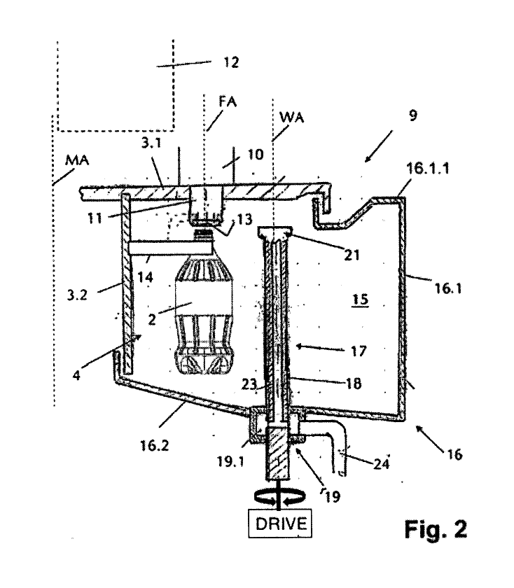

Referring to FIG. 1 a rotating filling machine 1 for the aseptic free-jet filling of containers 2 in the form of bottles with a liquid filling material includes a rotor 3 that can be driven to rotate around a vertical machine-axis MA. On a circumference of this rotor 3 are filling positions 4 that are formed at regular angular distances around the machine axis MA and that are all at the same radial distance from the machine axis MA. The containers 2 to be filled are supplied by an external conveyor 5 (arrow B) and are transferred to a filling position 4 at a container inlet 6. The filled containers 2 are removed from the filling positions at a container outlet 7 and supplied by an external conveyor 8 to a further treatment station (arrow C). As the rotor 3 rotates the filling positions 4 through the angles between the container inlet 6 and the container outlet 7, the filling positions 4 and the containers 2 provided on it move in an isolator formed by a housing 9, shown in FIG. 2. The volume of the housing 9 is kept as small as possible.

FIG. 2 shows one of the filling positions 4 and the housing 9 in one embodiment of the filling machine 1. Each filling position 4 includes a filling element 10 that is arranged on the circumference of the rotor 3 or on the circumference of a first rotor element 3.1 such that only a filling nozzle 11 of the filling element 10 projects beyond the underside of the first rotor element 3.1. In the illustrated embodiment, the first rotor element 3.1 is a disk that lies with its upper face and underside parallel to a plane that is perpendicular to and intersected by the machine axis MA.

The filling element 10 has a liquid channel, not illustrated, that is connected by a top end to a filling material tank 12 provided on the rotor 3. The filling-material tank 12 provides filling material to all the filling elements 10 of the filling machine 1. The filling-material tank 12 is at least partially filled with the filling material during the filling operation and on the bottom end of the filling material nozzle 11 opens in a discharge opening 13, or filling material outlet. During filling, the liquid filling material flows through the discharge opening 13 and into a particular container 2 through its container opening in a free jet. Inside the liquid channel, a liquid valve controls how much filling material enters the container 2.

Underneath the filling nozzle 11, each filling position 4 has a container carrier 14. In the illustrated embodiment, the container carrier 14 attaches to a second rotor element 3.2. The second rotor element 3.2 defines a cylinder that concentrically encloses the machine axis MA and stands radially separated from the machine axis by a distance that extends between the radially outer side of the second rotor element 3.2 to the machine axis MA. On the container carrier 14, a flange formed underneath the container mouth suspends the container 2 such that an axis of the container 2 lies on the same axis or substantially on the same axis as a filling element axis FA that is oriented parallel to the machine axis MA. Along the direction of the filling element axis FA, a gap separates the container mouth from the bottom end of the filling nozzle 11.

The filling process takes place as the rotation of the rotor 3 carries the container 2 around an angular range that extends between the container inlet 6 and the container outlet 7. During this filling process, the bottom end of the filling nozzle 11, the container carrier 14, and the container 2 that it holds, are all seated inside an isolator chamber 15 of the housing 9. The inside of the isolator chamber 15 is exposed to a sterile gaseous and/or vaporous treatment medium, for example to sterile air. Inside the isolator 15, there is a current of treatment medium. This current emerges at the container inlet 6 and at the container outlet 7 where the housing 9 is open or ends.

In the illustrated embodiment, the housing 9 adjacent to the isolator chamber 15 is formed from a rotating housing part and a stationary housing part 16. The rotating housing part, which is provided on the rotor 3 and circulates therewith, comprises the first and second rotor elements 3.1, 3.2. The stationary housing part 16 is provided on the machine rack of the filling machine 1 and, at an overlapping labyrinth seal, connects to the area of the first rotor element 3.1 lying radially outside relative to the machine axis MA, or to the bottom end of the second rotor element 3.2.

In the illustrated embodiment, the stationary housing part 16 comprises a vertical section 16.1 that defines an annulus that is concentric with the machine axis MA. An upper section 16.1.1 extends radially inwards from the vertical section 16.1 and forms the transition that ultimately couples to the first rotor element 3.1. A lower section 16.2 forms an inclined base of the isolator chamber 15 to drain liquid components. In this embodiment, the base surface is inclined such that it slopes downwards and radially outwards relative to the machine axis MA, thus directing liquid components away from the machine axis MA during drainage thereof.

A particular feature of the filling machine 1 is that the rinsing caps 17 that are assigned to the individual filling elements 10 do not rotate with the rotor 3. In the embodiment illustrated in FIGS. 1-3, each rinsing cap 17 includes a hollow shaft 18 that is arranged with a part of its length inside the isolator chamber 15, with its bottom end fed in a sealed manner out of the isolator chamber 15 through the lower section 16.2, and is mounted there with a rotary coupling 19. The rotary coupling 19 enables the rinsing cap 17 to be rotated or swiveled around its hollow-shaft axis WA, which is parallel to the machine axis MA.

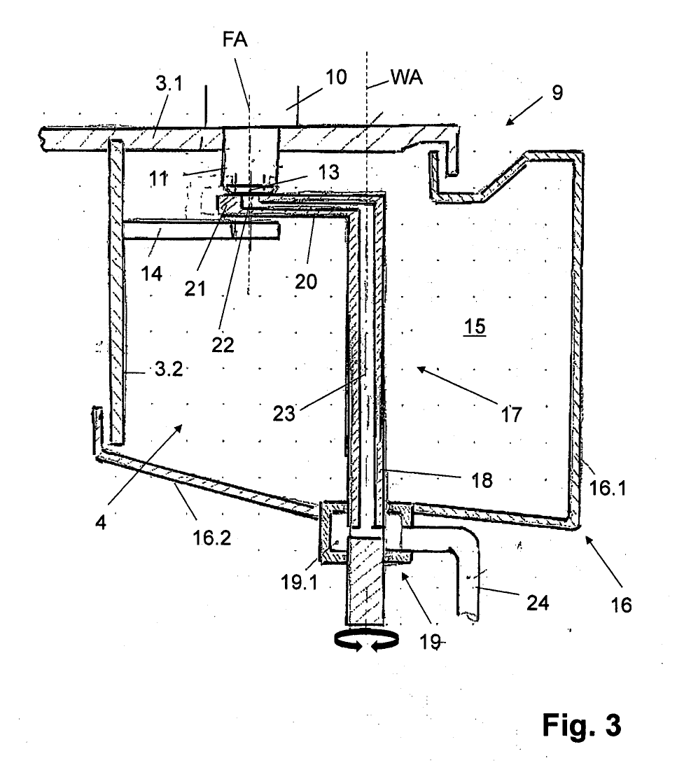

On the top end, which is arranged in the isolator chamber 15, the shaft 18 is fitted with a radially extending arm 20, best seen in FIG. 3. At its free end, the arm 20 forms a rinsing cap element 21 with a rinsing cap opening 22. The rinsing cap opening 22 is connected, by an outflow channel 23 formed partially in the arm 20 and partially in the shaft 18, to a return flow channel 24 via a drainage chamber 19.1 of the rotary coupling 19. The outflow channel 23 is open only at the rinsing cap opening 22 and at its outflow into the drainage chamber 19.1.

In the embodiments illustrated in FIGS. 2 and 3, the hollow shaft 18 is arranged such that the hollow-shaft axis WA is offset to be further from the machine axis MA than the filling element axis FA. The rinsing caps 17 are provided with their hollow-shaft axes WA distributed around the machine axis MA with an angular distribution that corresponds to the angular distribution of the filling elements 10. As a result, with the exception of the container inlet 6 and container outlet 7, a rinsing cap 17 is assigned to each filling element 10. At the container inlet 6 and at the container outlet 7, rinsing caps 17 are omitted to containers 2 to be supplied and removed from the apparatus by motion in the radial direction.

A drive acts on a lower end of the hollow-shaft 18 that extends beyond of the isolator chamber 15. As a result of the drive, the hollow-shaft 18 can be swiveled around its hollow-shaft axis WA by an angle of 90° or approximately 90° between a starting position and a working position. In the starting position, for the filling operation, the arms 20 and the rinsing cap elements 21 are arranged outside the movement path of the circulating filling elements 10, container carriers 14 and containers 2. In the working position, the arms 20 with their rinsing cap elements 21 are below a filling nozzle 11.

Moving the rinsing cap 17 along the filling element axis FA causes it to lie right against the filling nozzle 10, thus causing the rinsing cap opening 22 to connect tightly to the discharge opening 13 of the relevant filling element 10, for example by a seal. This movement along the filling element axis FA takes place by raising the rinsing caps 17 and/or by lowering the rotor 3 in the direction of the machine axis MA.

The treatment medium flowing through the liquid channel or other channels of the filling elements 10 during CIP cleaning and any condensate therefrom is drained into the return flow channel 24 by the outflow channels 23 of the rinsing caps 17. The return flow channel 24 can be provided jointly for all rinsing caps 17 or for a group of rinsing caps 17 depending on whether the drainage chamber 19.1 is made as an annular channel for all rinsing caps 17 or a group of such rinsing caps 17 together.

Both the drive for swiveling the rinsing caps 17 and the drive for delivery of the rinsing caps 17 to the filling nozzles 11 and the removal of the rinsing caps 17 from the filling nozzles 11 are located outside the housing 9 or the isolator chamber 15.

Inevitably, two of the filling elements 10 will, by chance, be located where there are no rinsing caps 17. Therefore, to capture all the filling elements 10 during CIP cleaning with the embodiment illustrated in FIGS. 2 and 3, it is necessary to undertake the treatment in at least two steps with the rotor 3 rotating between the treatment steps. Between the first and second steps, the rotor rotates enough to bring the two filling elements 10 that could not be cleaned to locations having a rinsing cap 17. Cleaning, and in particular CIP cleaning and/or sterilization, takes place with the rotor 3 stationary at a rotational position that places each rinsing cap 17 under a filling nozzle 11.

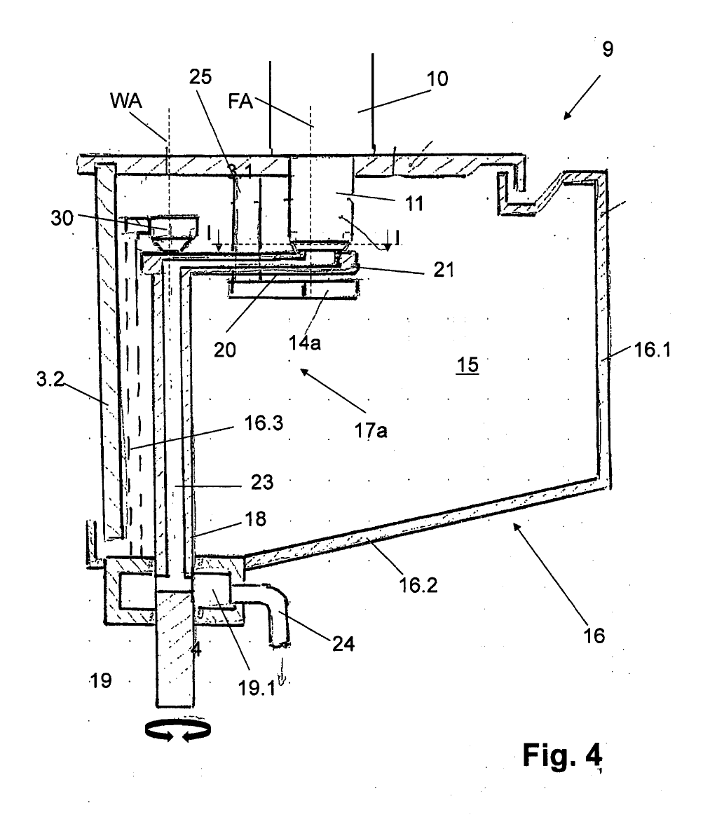

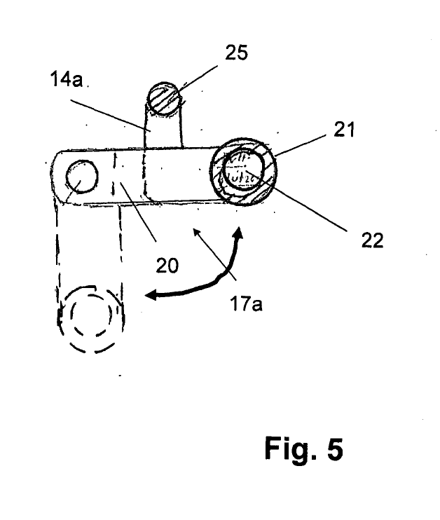

An embodiment shown in FIG. 4 differs from the embodiment in FIGS. 2 and 3 only in that the hollow-shafts 18 are arranged with their hollow-shaft axes WA radially relative to the machine axis MA within the movement path on which the filling elements 10 rotate with their filling element axes FA during the filling operation. To allow this, and in particular, to allow the rinsing caps 17 to swivel between the stationary position and the working position, the container carriers 14a that would have corresponded to the container carriers 14 in the first embodiment are made like an angle piece, as shown in FIG. 5.

FIG. 5 shows a container carrier 14a and a corresponding rinsing cap 17a. As is apparent, the container carrier 14a is made in such a way that its attachment on the first rotor element 3.1 and a section working with the containers 2 for holding, relative to the direction of rotation A of the rotor 3 are offset from each other by an angle so that it becomes possible to swivel the arms 20 with their rinsing cap elements 21 under the filling nozzle 11. A bolt 25 holds each angular-type container carrier 14a by a free end of a branch on the first rotor element 3.1.

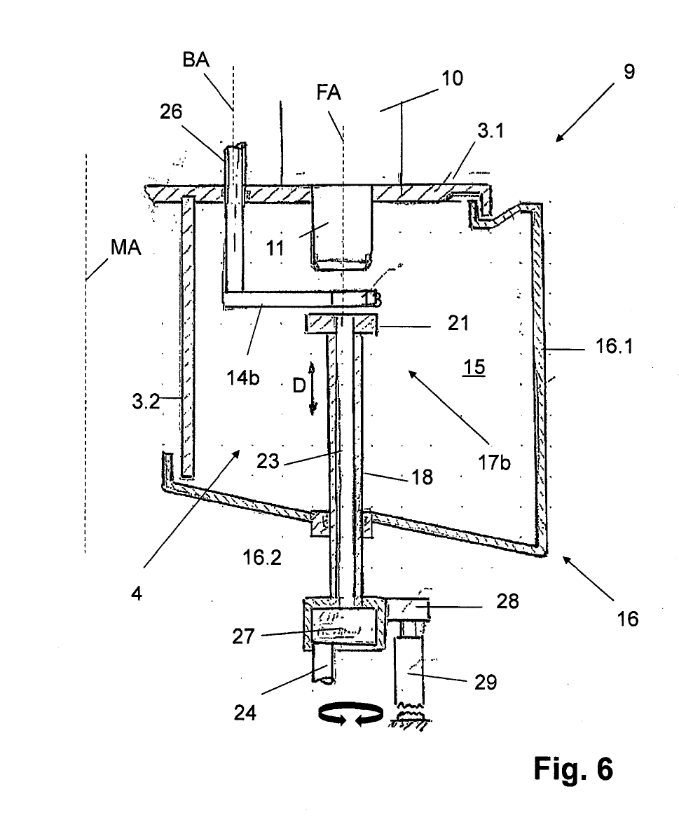

FIG. 6 shows an embodiment of the filling positions 4 that differs from the filling positions in FIGS. 2-5 because the container carriers 14b are held on a shaft 26 such that they can swivel around a container carrier axis BA that is parallel to the machine axis MA to enable them to swivel between a working position and a non-use position. In the working position, the container carrier 14b is located underneath the filling nozzle 11. In the non-use position, the container carrier 14b is located to the side of the filling nozzle 11, i.e. offset radially inwards against it relative to the machine axis MA.

In the embodiment of FIG. 6, a rinsing cap 17b has a shaft 18. This shaft 18 is arranged with its axis at the same radial distance from the machine axis MA as the filling element axis FA. As a result, during cleaning, each filling element 10 is arranged with its filling element axis FA on the same axis as the axis of a rinsing cap 17b or its shaft 18.

A top end of the shaft 18 is made directly with the rinsing cap element 21 forming the rinsing cap opening 22. The shafts 18 are made so that they can move in an axial direction, which is shown by a double arrow D, and so that they are sealed by the housing element 16.2. The lower end of the outflow channel 23 of each shaft 18 opens into a fluid channel 27 to which, in turn, the return flow channel 24 is connected. In one embodiment, the return flow channel 24 takes the form of a flexible pipe to remove the treatment medium. The fluid channel 27 is preferably an annular channel for all the rinsing caps 17b together on a rotating carrier ring 28 that concentrically surrounds the machine axis MA. The carrier ring interacts with a lifting device 29 that raises and lowers all the rinsing caps 17b. In one embodiment, a lifting cylinder forms the lifting device 29.

In the foregoing embodiment, treatment of the filling elements 10 takes place in such a way that, with the rotor 3 halted and the filling elements 10 arranged with their filling element axes FA on the same axis as the axes of the rinsing caps 17b, the container carriers 14b are swiveled into their non-use position. Then, the lifting device 29 causes all the rinsing caps 17b to be inserted or raised so far into the isolator chamber 15 that they lie sealed with their rinsing cap elements 21 positioned tightly against a filling nozzle 11.

The treatment medium flowing through the filling elements 10 is drained by the outflow channels 23, the fluid chamber 27, and also the return flow channel 24. After cleaning and/or sterilization, the rinsing caps 17b are moved back to their lower starting position with a long stroke, so that they are located with their rinsing cap element 21 underneath the movement path along which the containers, which are held suspended on the container carriers 14b, travel during the filling operation. Before the filling operation is commenced, the container carriers 17b are swiveled back into their working positions.

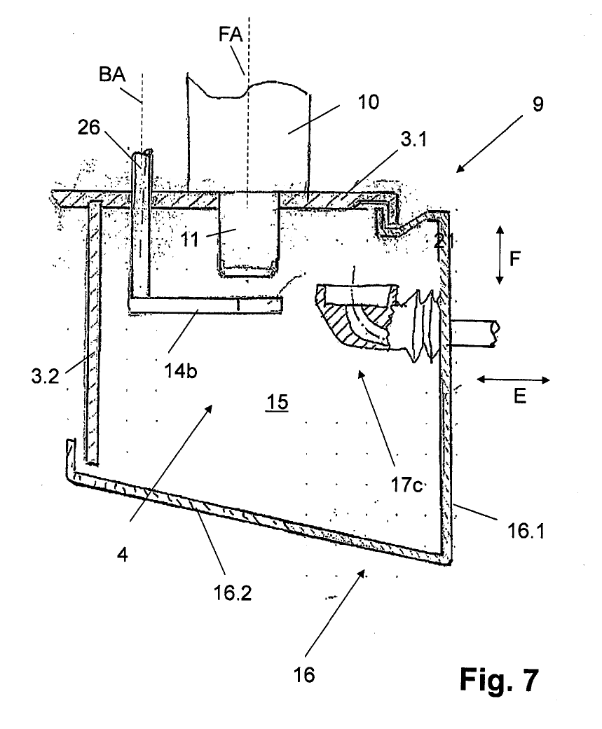

FIG. 7 shows an embodiment in which the rinsing caps 17c can be moved radially, along the path shown by a double arrow E, relative to the machine axis MA, on the housing element 16.1 for delivery to the filling nozzles 11 of the filling elements 10 and for removal from these filling nozzles 11. In the embodiment shown, it can also be particularly advantageous if the rinsing caps 17c can additionally be raised and lowered along the direction shown by a double arrow F in the direction of the filling element axis FA.

The invention was described above using various examples of embodiments. It is clear that numerous modifications and variations are possible without thereby departing from the inventive idea underlying the invention.

For example, in an alternative embodiment, a closure 30 is provided for each rinsing cap. The closure closes the rinsing cap opening 22 during the filling operation. Such a closure is shown in FIG. 4. In the illustrated embodiment, the stationary housing part 16 is formed with a further internally located annular housing element 16.3 that concentrically surrounds the machine axis MA. The closures 30 are held on the housing element. The second rotor element 3.2 can then be made correspondingly shorter.

Common to all embodiments is that the rinsing caps 17, 17a-17c are not provided on the circulating rotor 3 or on elements of the circulating rotor 3. Instead, they are provided on a stationary element of the filling machine that is not circulating with the rotor. In the particular embodiment shown, the stationary element is the stationary housing part 16.

Also common to all embodiments is that, where a housing 9 surrounding an isolator chamber 15 is used, all actuating drives or their elements for the delivery and removal of the rinsing caps 17, 17a-17c onto the filling elements 10 or from the filling elements 10 are arranged outside the isolator chamber 15. This greatly reduces the number of the elements inside the isolator chamber 15 that need to be cleaned and/or sterilized. In addition, this makes it possible to avoid areas at which the treatment medium or its condensate could collect during the cleaning and/or sterilization of the isolator chamber 15.

In all the embodiments described herein, removal of the treatment medium following CIP cleaning and/or sterilization requires no aseptic or structurally elaborate rotary connection between the rotor 3 and the stationary machine rack of the filling machine 1. Instead, removal of the treatment medium takes place in the aforesaid manner in a simplified way using the rinsing caps 17, 17a-17c provided on the rotor 3.

The invention has been explained above in the context of free-jet filling. However, the present invention applies to all filling methods with counter-pressure. The use of an appropriate filling valve and the measures necessary for this are familiar enough to one of ordinary skill in the art so that no detailed description of a corresponding example of such an embodiment is needed.

Furthermore, the invention has been explained above solely using an example in which containers, at least during one section of the production process, are held on a neck ring arranged underneath the mouth. However, the present invention can also be used for containers that do not have a neck ring and that thus stand on their container base during the production process. The measures needed for implementing such an embodiment, namely designing the container carrier not as a seating element for the neck ring of a container, but as a standing plate to take the container base, has long been known to the person skilled in the art. The measures necessary implementing such an embodiment would be familiar enough to one of ordinary skill in the art so that no additional disclosure of such an embodiment is required.

In the context of the present invention, the term “container carrier” is to be understood either as a neck ring seat or a container standing plate depending on the particular case.

Having described the invention, and a preferred embodiment thereof, What is claimed as new, and secured by Letters Patent is:

1-12. (canceled)

13. An apparatus for filling containers with liquid filling material, said apparatus comprising a filling machine, wherein said filling machine comprises a transport element, filling positions, rinsing caps, and a housing, wherein each filling position comprises a filling element and a container carrier, wherein said transport element is rotatable about a machine axis, wherein said filling element forms a discharge opening for said filling material, wherein said filling positions are formed on said transport element, wherein each rinsing cap is assigned to a filling position, wherein each rinsing cap is movable between a starting position and a working position, wherein in said starting position, said rinsing cap is arranged outside a movement space through which said filling elements move during a filling operation, wherein in said working position, said rinsing cap forms a cleaning path that includes said discharge opening, wherein said rinsing caps are disposed on a stationary part of said housing, wherein said stationary part of said housing is stationary relative to said transport element.

14. The apparatus of claim 13, wherein said housing that forms an isolator chamber, and wherein said filling element is disposed in said isolator chamber during filling of containers by said filling element.

15. The apparatus of claim 14, further a drive that moves said rinsing cap, said drive being disposed outside said isolator chamber between said starting and working positions.

16. The apparatus of claim 13, wherein said rinsing cap is configured to swivel around a swivel axis thereof when moving between said starting position and said working position.

17. The apparatus of claim 16, wherein said swivel axis is oriented to be parallel to said machine axis.

18. The apparatus of claim 16, wherein said swivel axis is disposed outside a movement path along which said filling elements rotate about said machine axis as a result of being moved by said transport element.

19. The apparatus of claim 16, wherein said swivel axis is disposed inside a movement path along which said filling elements rotate about said machine axis as a result of being moved by said transport element.

20. The apparatus of claim 13, wherein said rinsing cap is configured to move along an axis when moving between said starting position and said working position, wherein said axis along which said rinsing cap is configured to move is an axis that is parallel to said machine axis.

21. The apparatus of claim 13, wherein said rinsing cap is configured to move along an axis when moving between said starting position and said working position, wherein said axis along which said rinsing cap is configured to move is parallel to a filling element axis of a filling element of a filling position assigned to said rising cap.

22. The apparatus of claim 13, wherein said rinsing cap is movable along a line.

23. The apparatus of claim 13, wherein said rinsing cap is configured to seal tightly against said filling element in said working position to form said cleaning path as a result of relative movement between said rinsing cap and said filling element in an axial direction that is parallel to a filling element axis of said filling element.

24. The apparatus of claim 13, wherein said rinsing cap is configured to seal tightly against said filling element in said working position to form said cleaning path as a result of relative movement between said rinsing cap and said filling element in an axial direction that is parallel to a swivel axis of said rinsing cap.

25. The apparatus of claim 13, wherein said rinsing cap further comprises a return flow channel for treatment medium, wherein said treatment medium is selected from the group consisting of cleaning medium and sterilization medium.

26. The apparatus of claim 13, wherein said housing comprises a movable part, wherein said movable part rotates with said transport element, and wherein said movable part overlaps said stationary part.

27. The apparatus of claim 13, further comprising a closure, wherein when said rinsing cap is in said starting position, said closure closes said rinsing cap.

28. The apparatus of claim 13, wherein said filling machine comprises a free jet filling machine.

29. The apparatus of claim 13, wherein said filling machine comprises a counter-pressure filling machine.
